(19) United States
(12) Patent Application Publication
(10) Pub. No.: US 2026/0023849 A1
(43) Pub. Date: Jan. 22, 2026

(54) Identifying Libraries Included in Applications Based on Analysis of the Application Code

(71) Applicant: Kryptowire Inc., Arlington, VA (US)

(72) Inventors: Mohamed Elsabagh, Arlington, VA (US); David A. Tomassi, Arlington, VA (US)

(21) Appl. No.: 18/779,806

(22) Filed: Jul. 22, 2024

(51) Int. Cl. G06F 21/56

(52) U.S. Cl. CPC G06F 21/563; G06F 2221/033

(57) ABSTRACT

The present disclosure provides computer-implemented methods, systems, and devices for identifying third-party libraries included in applications. A computing system accesses application content for a respective application; wherein the application content includes a plurality of instructions associated with the application and the instructions are grouped into methods. The computer system generates one or more software signatures for the respective application based on an analysis of the plurality of instructions. The computer system determines that the one or more software signatures match one or more stored software signatures from a plurality of stored software signatures stored in a database of known software signatures. The computer system determines based on the one or more stored software signatures that match the one or more software signatures, one or more software issues within the respective application. The computer system transmits data describing the one or more software issues for display.

The present disclosure relates generally to security for computing systems. More particularly, the present disclosure relates to automatically identifying third-party libraries included in applications based on an analysis of the executable code of the application.

### BACKGROUND

As computer technology has improved, the number and type of services that can be provided to users have increased dramatically. The services provided via computer technology can employ one or more computer applications to perform the services. However, computer applications can have flaws or malicious code that reduce the security and effectiveness of a particular application.

### SUMMARY

Aspects and advantages of embodiments of the present disclosure will be set forth in part in the following description, or can be learned from the description, or can be learned through practice of the embodiments.

An example aspect is directed toward a computer-implemented method. The method comprises accessing, by a computing system including one or more processors, application content for a respective application; wherein the application content includes a plurality of instructions associated with the application and the instructions are grouped into methods. The method further comprises generating, by the computing system, one or more software signatures for the respective application based on an analysis of the plurality of instructions. The method further comprises determining, by the computing system, that the one or more software signatures match one or more stored software signatures from a plurality of stored software signatures stored in a database of known software signatures. The method further comprises determining, by the computing system, based on the one or more stored software signatures that match the one or more software signatures, one or more software issues within the respective application. The method further comprises transmitting, by the computing system, data describing the one or more software issues for display.

Another example aspect of the present disclosure is directed to a computing system. The computing system comprises one or more processors; and a computer-readable memory. The computer-readable memory stores instructions that, when executed by the one or more processors, cause the system to perform operations comprising accessing application content for a respective application; wherein the application content includes a plurality of instructions associated with the application and the instructions are grouped into methods. The operations further comprise generating one or more software signatures for the respective application based on an analysis of the plurality of instructions. The operations further comprise determining that the one or more software signatures match one or more stored software signatures from a plurality of stored software signatures stored in a database of known software signatures. The operations further comprise determining based on the one or more stored software signatures that match the one or more software signatures, one or more software issues within the respective application. The operations further comprise transmitting data describing the one or more software issues for display.

Another example aspect of the present disclosure is directed towards a computer-readable medium storing instructions. The instructions, when executed by one or more computing devices, cause the device to perform operations comprising accessing application content for a respective application; wherein the application content includes a plurality of instructions associated with the application and the instructions are grouped into methods. The operations further comprise generating one or more software signatures for the respective application based on an analysis of the plurality of instructions. The operations further comprise determining that the one or more software signatures match one or more stored software signatures from a plurality of stored software signatures stored in a database of known software signatures. The operations further comprise determining based on the one or more stored software signatures that match the one or more software signatures, one or more software issues within the respective application. The operations further comprise transmitting data describing the one or more software issues for display.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a method for detecting software libraries according to example embodiments of the present disclosure;

FIG. 2 is an example library identification system associated with a computing system according to example embodiments of the present disclosure;

FIG. 3 represents a representation of the structure of an application before and after code shrinking according to example embodiments of the present disclosure;

FIG. 4 is an example of a process for detecting software libraries in an application in accordance with the example embodiments of the present disclosure;

FIG. 5 depicts an example computing system in accordance with example embodiments of the present disclosure;

FIG. 6 depicts an example client-server environment according to example embodiments of the present disclosure;

FIG. 7 depicts a method level hash and a library level hash according to example embodiments of the present disclosure;

FIG. 8 depicts a process for encoding computing instructions according to example embodiments of the present disclosure; and

FIG. 9 depicts an example flow diagram for a method of detecting software libraries associated with the according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed towards a system to identify third-party libraries included in a computing application. Identifying the third-party libraries included in an application is vital to computer security because third-party libraries can have flaws, insecurities, or malicious code. Knowing which third-party libraries are included in a particular application can enable a user to determine whether or not to use that application. However, once the application code has been converted into executable instructions (e.g., compiled), it can be difficult for a user, even a sophisticated user, to determine which third-party libraries have been included in a particular application. Third-party libraries are included in most applications because they add functionality to the application that would otherwise have to be reproduced by hand by the creators of that application. As a result, third-party developers generate libraries for every computer programming language to reduce the overhead of developing an application in that language.

Once the computing application has been completed (e.g., third-party libraries have been incorporated into the application code, and the application code has been compiled into a series of executable instructions) and made available to users, the developers may not publicly publish a list of third-party libraries included in their application. In addition, developers may intentionally obfuscate their code to prevent reverse engineering by rivals. As a result, if a flaw or insecurity becomes known for a particular third-party library, users generally will not know which applications include that flaw. In some cases, the application developers may be unaware of newly discovered flaws or insecurities and thus are not prepared to monitor such insecurities or alert users of their applications. In other examples, malicious developers can intentionally include malicious code from third-party libraries in their applications. It is helpful for a user to have a reliable way to determine whether a particular application contains third-party libraries with flaws or malicious code.

The present disclosure describes the system that enables users to reliably determine which third-party libraries have been included in each application based only on its compiled executable instructions. To do so, the system first accesses a plurality of third-party libraries of which the system is aware. Developers of third-party libraries can make those third-party libraries publicly available (e.g., in software library repositories). In some examples, a system can determine that a third-party library includes malicious code based on an automated review of the library code. In other examples, the presence of malicious code in a particular third-party library may be determined based on a documented malicious attack in which the malicious code was used to compromise the system of one or more users. The library detection system can store a list of libraries with known malicious code that is updated as more information becomes available.

Once the library detection system accesses one or more third-party libraries, the library detection system can generate a software fingerprint for each third-party library. The third-party libraries can be made publicly available for software developers to use. Thus, the library detection system can access the third-party libraries from publicly available server systems. Software fingerprints can be generalized representations of the third-party software library, enabling the system to match against other applications to determine whether they include the same third-party library.

The library detection system can first identify code module (e.g., root package) within the library to generate the software fingerprints. For example, a library can include a series of code modules. Because libraries can consist of multiple different functionalities, only one particular code module of the library may be included in an application. By generating different software fingerprints for different code modules of the library, the library detection system can determine that the application includes a portion of a particular library, even if it does not include the entire library. Suppose software fingerprints were generated only for the whole third-party library. In that case, the system may fail to detect instances where the developers of an application include only one portion (e.g., a single code module associated with a particular functionality offered by the third-party library) of the third-party library in the application and exclude other, unneeded portions of the third-party library.

For each code module, the library detection system can determine information such as the name of the classes within a particular code module, the input to one or more classes (or methods within the classes), the return values of one or more classes (or methods within the classes), and the content of the classes (e.g., the methods within each class and their content). The content of a method can include a series of operations performed in the method used to generate a return value based on the received arguments. For example, the library detection system can determine the type of data input as arguments and the type of data output as a return value. Similarly, the library detection system could determine the particular operations performed in the body of the methods for a class or other code subsection.

Once the code modules (e.g., root packages) are determined and the variety of information about them is determined, the library detection system can encode information about the route packages (or other code modules) using a fuzzy encoding method. The library detection system can use the fuzzy encoding method to prevent itself from learning too detailed representation of the code modules. If the library detection system represents the subsections or libraries too accurately, obfuscation techniques will make it very difficult to determine whether a particular library or subsection of the library is present within the code. Encoding these code modules can enable the library detection system to represent the libraries (or subsections of libraries) at a lower resolution to prevent overlearning (e.g., having too detailed a representation to defeat code obfuscation) while still containing the instructions, which prevents underearning (e.g., not having a detailed enough representation in which case the library detection system may present false positives or fail to detect the third-party libraries at all).

For example, the library detection system can extract the body of the methods or classes (or other relevant code subsections) by mapping particular instruction codes onto specific symbols. In doing so the library detection system can represent the instructions of a code subsection as a string of symbols. In some examples, multiple instruction codes can be mapped to this same symbol, and the instruction operands can be discarded. By mapping several instructions to the same symbol, the content of a code subsection can be represented at a higher level of generality. Thus, changes that affect the form or appearance of the third-party library (or subsection of the library) but do not change the function of the code will not change the representation of that third-party library in its encoded form.

Once the third-party libraries and/or subsections of those third-party libraries have been encoded, the system can generate a software signature for the library and or subsection of the library. For example, for each method in a class group, the library detection system can extract the method parameter return type and the encoded body. This signature can include a header, which represents the class name, the arguments (e.g., input), the return type, and the body which is the encoded instructions from the body of the method within the class.

In some examples, to compute the signature header, the library detection system can use a fuzzy method descriptor to transform these aspects of the method into a low-resolution representation. For example, the data types of the arguments can be retained in some situations or abstracted out in others. In some examples, the data types of the method arguments and return values can be kept if the type is a primitive. However, if the type is non-primitive, the specific type of argument or return type can be abstracted out to be represented by a more generic symbol or character.

When generating a representation of the signature body, including the encoded body, the library detection system can generate a hash of the encoded body using a context-triggered piecewise hashtag. The generated signature, including the header and the hashtag body, can be stored in a library software storage system four later use.

Once a plurality of software signatures for third-party libraries has been stored in a database, the library detection system can use the stored software signatures to determine whether particular applications include any of these libraries for which software signatures have been stored. For example, a user can request that a respective application be analyzed to decide whether or not it includes any problematic third-party libraries. In response to that request, the library detection system can access the files associated with the respective application to determine which third-party libraries (if any) are included in the respective application.

The library detection system can analyze the application to determine one or more library candidates. Library candidates can be portions of the code that may be generated based on imported third-party libraries. In some examples, the application includes a package hierarchy that identifies all the application root packages. The library detection system can traverse this hierarchy to identify all of the main components of the application and their packages. In some examples, the library detection system can discard root packages that belong to the main components since these are generally part of the application's code written by the applications developers and not imported from third-party libraries.

Once the list of candidate sections is determined, the library detection system can encode the methods and construct their software signatures using the same process that was used when generating a software signature for the third-party library. More specifically, the library detection system can access the instructions for the application (e.g., from the applications Android Package file (APK) or equivalent), identify one or more software modules (e.g., root packages or other software subsections), and uses the data associated with each software module to generate a software signature for each software module. The library detection system can distinguish between the header of the signature and the body of the signature. The body of the signature is generated by encoding the instructions in one or more methods included in the software module into an encoded representation.

The library detection system can be designed to handle various scenarios, including obfuscated application code. It achieves this by converting each instruction into a particular symbol to encode the instructions. Moreover, the library detection system can map multiple instructions to the same symbol. For instance, instructions that can be used to achieve the same outcome may be mapped to the same symbol. This adaptability ensures that the resulting signature will still be detectable even if the application code has been obfuscated. Once the body of one or more methods in the code module has been encoded, the library detection system can generate a signature for the code module. The library detection system can generate the header signature based on the parameter types, return type, and the encoded body.

As mentioned above, the header is generated using a fuzzy method descriptor that represents portions of the input, output, and encoded body in a generalized way. When the library signature is generated, the arguments or inputs that have a primitive type can retain those types, whereas the non-primitive inputs may be represented as an abstraction. Similarly, the names and output of the system can also be abstracted.

Once the header has been generated, the signature can be generated for the body based on the encoded sequence using a hash function (e.g., a context triggered piecewise hash process). The first part of the hash can be the size of the rolling window used to calculate each passing part, and the second part can be a hash computed with the chunk size. A third part could be a hash with the chunk size doubled. This approach enables handling both coarse and fine grade changes within a sequence due to obfuscation.

Once one or more software signatures have been generated for the target application, the library detection system can compare the generated software signatures to the software signatures stored in the signature library. In some examples, the library detection system can first reduce the possible number of candidate matches in the library of signatures based on one or more narrowing conditions.

For example, the system can determine whether the current candidate software signature from the target application has a name that matches the names of target third-party libraries in the library database. This process can filter out irrelevant library signatures so that the library detection system can limit the number of stored software signatures that are compared against one or more software signatures for the target application. Similarly, the library detection system can determine the number of classes or subsections in the current library candidate software signature and compare it to the number of classes in the stored software signatures. If the number of classes for the stored library signature is not within a predetermined threshold from the number of classes in the current candidate software signature, that respective stored library signature can be excluded from the current comparison.

Once the total number of stored software signatures has been filtered to determine a plurality of candidate stored software signatures, The library detection system can determine a similarity between each stored software signature in the list of filtered stored software signatures and a respective software signature for the target application. For example, for each library candidate signature C and stored library signature (L), the library detection system can calculate a pairwise similarity score (M). The similarity score can be calculated as follows:

$$\begin{matrix}M = \{ 〈 {m}_{c} , {m}_{L} 〉 \vert {m}_{c} ∈ {M}_{c} , {m}_{L} ∈ {M}_{L} , S ( {m}_{c} ) \\ = S ( {m}_{L} ) , Δ ( H ( {m}_{c} ) , H ( {m}_{L} ) ) \leq δ \}\end{matrix}$$

In this example, S is the fuzzy method signature function, H is the fuzzy method hash function, Δ is a distance function, such as the Levenshtein distance, which represents how similar the two software signature hashes are to each other, and δ is a predefined threshold. For example, if the similarity score is a value between 0 and 1, the predefined threshold can be 0.85. The threshold δ can be tuned to enable the library detection system to continue to detect libraries even when changes are made in the method instructions due to intentional obfuscation. The threshold can be determined based on practical experience in detecting third-party libraries.

Once the pairwise similarity score (M) has been calculated, the library detection system can compute a final similarity score as the weighted sum of the ratios of matched methods in the library and the application. This weighted sum can be presented as:

$$sim ( C , L ) = α \cdot \frac{min ( \vert {M}_{L} \vert , \vert M \vert )}{{M}_{L}} + β \frac{min ( \vert {M}_{L} \vert , \vert M \vert )}{{M}_{C}}$$

where α, β are weighted parameters such that α+β=1. In some examples, the final similarity score ranges from 0 (lowest) to 1.0 (highest). The weighted parameters can enable the system to adapt to different degrees of code shrinkage by dampening the impact of code removal on the overall similarity score.

The weighted parameters can enable the library detection system to adapt to different degrees of code shrinkage by dampening the impact of code removal on the overall similarity score. In some examples, setting a to 0.8 and β to 0.2 yielded satisfactory overall results when code shrinking has been applied or a shared root package exists between libraries. The latter scenario arises when multiple libraries are associated with the same root package, potentially resulting in a low match ratio for the library candidate.

Once a similarity score has been generated for all applicable stored library signatures, the library detection system can rank them from most to least similar. The library detection system can determine one or more stored library signatures that satisfy a particular threshold. In some examples, the threshold is a predefined number of the most similar results. For example, the library detection system can select the one stored library signature with the highest final similarity score and determine that it is likely included in the application. In some examples, more than one third-party library can be included in an application, so the number of selected stored library signatures can be higher than one.

In some examples, the threshold can be between 0 and 1, representing confidence that the stored library signature represents a third-party library included in the application. In some examples, any stored library signature that has a final similarity score that exceeds the threshold value can be determined to be included in the application.

The library detection system can determine the library associated with each stored library signature that satisfies the threshold. The library detection system can determine, for each library determined to be included in the target application, whether any issues exist that should be reported to a user. Issues can include vulnerabilities, errors, or malicious code. The library detection system can generate a report including a list of all third-party libraries determined to be included in the target application and any associated flaws, vulnerabilities, malicious code, etc., associated with each third-party library. In some examples, the report can include a recommendation indicating whether the target application is safe to install. In some examples, the report can include potential alternative applications that have fewer flaws. The report can be transmitted to a user for display.

The systems and methods of the present disclosure provide a number of technical effects and benefits. As one example, the proposed systems can efficiently and accurately evaluate an application without access to the plain source code to determine which third-party libraries have been included in the application. Accurately and efficiently determining the third-party libraries included in a particular application can improve the security and performance of a user's computing device. Specifically, third-party libraries that have flaws or malicious code can introduce serious security threats to user computing devices that execute applications with those third-party libraries. Notifying a user of the potential vulnerabilities of an application can enable users to reduce potential security threats to the user's computing device. In addition, third-party libraries can introduce flaws (such as memory leaks). The user can be notified that particular applications (or versions of applications) will introduce inefficiencies to the computing system. Thus, this system can increase the security and efficiency of the computing device without adding additional significant costs. The increased security represents an improvement in the functioning of the device itself.

With reference now to the Figures, example embodiments of the present disclosure will be discussed in further detail.

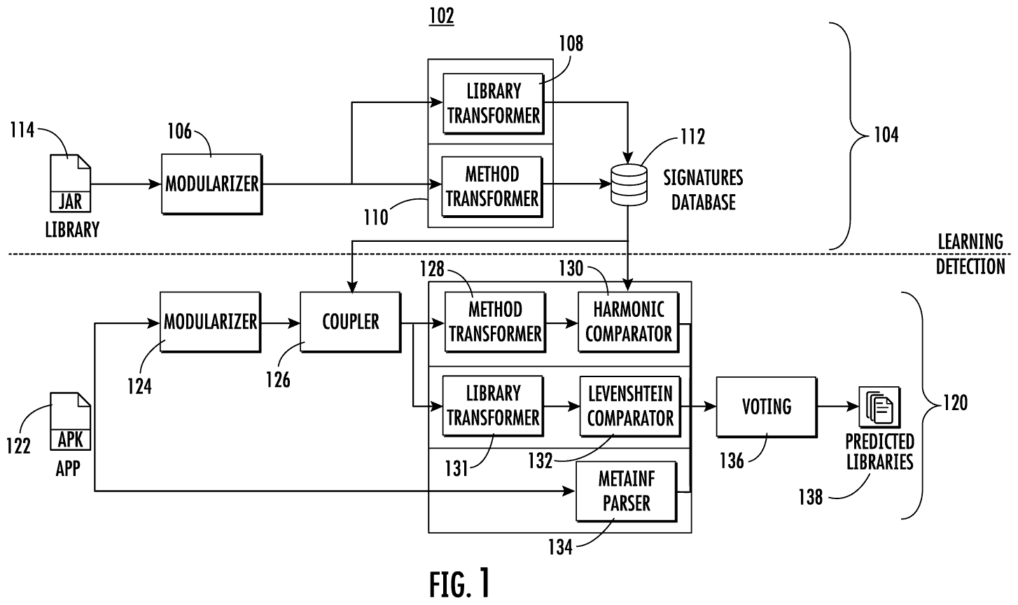

FIG. 1 depicts a method for automatically detecting third-party libraries within applications according to example embodiments of the present disclosure. The library detection system 102 can include a library storage system 104 and an application analysis system 120.

In some examples, the library storage system 104 can include a modularizer 106, a method transformer 110, a library transformer 108, and a signature database 112. The library storage system 104 can analyze known third-party libraries to generate software signatures for each library or library subsection. These software signatures can be stored for later comparison with target applications. The first step in generating a software signature for a particular third-party library is to access the third-party library 114.

Once the third-party library 114 has been accessed, a modularizer 106 can access information about the structure of the third-party library. In some examples, the third-party library can include hierarchical information for the code within the library. For example, the third-party library can include a package hierarchy. This hierarchy can be traversed in a breadth-first order to identify a first non-empty package (e.g., a root package).

The hierarchical data can be used to segregate the library into distinct code modules (or other code subsections). For example, a particular third-party library may include a large number of different modules that provide various functionalities. Because a specific application may not use all of the modules or functionality provided by a particular library, it is useful to generate separate software signatures for each code module (e.g., root nodes or classes without overlap). In this way, the modularizer 106 can determine if a specific code module (or other subsection) of the third-party library is included in the target application (even if other subsections are not included).

The modularizer 106 can iterate through potential code modules (e.g., the listed root nodes or classes) and segment them based on the hierarchical information. For example, classes and methods can be grouped into the same code module as the parent classes (or methods) in the hierarchy. In some examples, the software subsections can be grouped based, at least in part, by the interactions between the varies software subsections. In some examples, the modularizer 106 can determine which classes subsume the classes below it. Based on this iteration, the modularizer 106 can create distinct code modules made up of classes (or other software subsections) which are grouped together based on their interactions. For example, classes or other subsections that reference each other can be grouped because any application that access a subsection must also include any subsection which is called referenced by the first sub section. As discussed above, this enables the library identification system 104 to determine when a particular portion of a third-party library is present in an application, even if other portions are not.

Once the modularizer 106 has determined a list of independent code modules within the third-party library, that list can be passed to the library transformer 108 and the method transformer 110. The library transformer 108 can generate a software signature for the entire library. This software signature can represent the functionality of the combined library. By generating one software signature for the entire library, the library detection system 102 can determine when an entire library has been included in an application.

The method transformer 108 can generate a software signature for each code module in the list of code modules. The method transformer 110 can generate an encoded string representing the content of each method included in a particular code module. The method transformer can use fuzzy method descriptors provide a header for the code module.

The method transformer 110 can generate a signature header which represents the parameters and return types for each method in the code module. for each method. The method transformer 110 can also generate a signature body for a code module using fuzzy hashes to transform the encoded representation of the instructions of the methods in the code module. The signature header and the signature body can be combined to create a distinct software signature for each independent code module within a particular third-party library. If only a portion of the third-party library is included in a particular application, the library detection system 102 can still identify the particular code module.

Once the library storage system 104 has generated a plurality of software signatures from the entire library and particular code modules (e.g., root nodes or other code subsections), the library storage system 104 can store those signatures in a signature database 112. The signature database 112 can be a database that stores all the software signatures for a plurality of known third-party libraries. The signatures stored in the signature database 112 can be compared against signatures generated from applications to determine whether the application includes any particular methods or portions of those libraries. The signatures database 112 can be used by the application analysis system 120 for comparison to target applications.

The application analysis system 120 can include a modularizer 124, a coupler 126, a method transformer 128, a harmonic comparator 130, a library transformer 131, a Levenshtein comparator 132, a meta-information parser 134, and a voting system 136.

When a particular application is determined to be analyzed (e.g., based on a user request, or other method of determining a specific target application), the application analysis system 120 can access the application in executable format 122 (e.g., android package (APK)). The executable application (and supporting files as needed) can include all instructions necessary for the application to perform its intended tasks. For example, the executable application can include byte code files, resource files, and assets. The bytecode is organized into package hierarchies, e.g., com/example, where each package in the hierarchy may contain one or more implementation units (a class file) and other subpackages. The APK contains both the app's own bytecode as well as the bytecode for all the third-party libraries (and their transitive dependencies) on which the application depends. In some examples, the application can include code from third-party libraries. As discussed above, third-party libraries can enable developers to use functionality without having to create the functionality themselves.

The modularizer 124 can disassemble the executable application to access information about the structure of the application. The modularizer can access information about the package hierarchy of software within the application. In some examples, the hierarchy has one or more root packages. The modularizer 124 can identify, based at least in part, on the one or more root packages a list of code modules (e.g., classes or other code subsections) of the applications. The modularizer 124 can iterate through the code modules and segment the code segments into packages that have implementation and subsume the packages below it. For example, if a particular class is included entirely in another class, those two classes can be grouped into a specific code module (or package). However, classes that are independent of each other may not be grouped into the same package.

Once the modularizer 124 has generated a list of independent code modules, the coupler 126 can, for each code module in the application, determine whether it matches a third-party library based on signatures in the signatures database 112. In some examples, the coupler 126 can filter potential matches in the signature database 112 based on name matches between the two modules. However, in some cases, the names will be obfuscated either intentionally or unintentionally. In this case, the application analysis system 120 can determine matches based on the number of classes and or methods in a particular package. Similarly, the application analysis system 120 can determine whether the difference in the number of methods slash classes is below a threshold. Filtering the stored software signatures to remove software signatures for libraries (or code modules) with too many or too few methods can enable the application analysis system 120 to reduce the search space for these comparisons. Reducing the search base can reduce the time needed to perform these comparisons.

Once the coupler 126 has reduced the search space for the particular library and/or any independent modules in the library, the coupler 126 can pass the list of independent modules to the method transformer 128 and the library transformer 131. As mentioned above, the library transformer 131 can generate a software signature for the entire library. The method transformer 128 can generate a software signature for each independent module.

The method transformer 128 can transfer the generated software signatures to a harmonic comparator 130. The harmonic comparator can compare each software signature to several signatures from the stored signature database 112. The harmonic comparator 130 can calculate the harmonic similarity between a candidate software signature from the target application with one or more stored software signatures to estimate whether the third-party libraries associated with the one or more stored software signatures are included in the target library. The harmonic comparator 130 can determine the geometric central tendency of a group of fuzzy hashes. This results in an overall similarity score of how similar a candidate software signature from the target application is to a software signature for a third-party library.

The harmonic comparator 130 can determine a similarity score between sets of method signatures based on whether they have similar geometric tendencies. This is done by, first, computing a normalized score of the fuzzy signature bodies of signatures with matching headers between the two sets, then computing the geometric central tendency of the resulting set of normalized similarity scores. In some examples, comparing the central tendency between two signatures (or sets of signatures) is similar to measuring if two sets of melodies have a similar rhythm.

The Levenshtein comparator 132 can compare a library signature received from the library transformer 131 against one or more library signatures stored in the signatures database 112. To do so, the Levenshtein comparator 132 can generate a Levenshtein distance between the software signatures (e.g., fuzzy hashes) for each pair (e.g., the current library from the application and a candidate library hash stored in the signature database 112). The Levenshtein distance can represent the similarity between two values by determining the number of edits needed to match the two values (in this case hashes). This can give an overall similarity score between a software signature for a target application and a stored software signature stored in the signatures database 112.

The meta information parser 134 can parse through files in the meta information directory that may be included in a particular application's APK. This information may include libraries and their respective versions. Using this information, the meta-information parser 134 can iterate through each file to find data that will enable it to match patterns to a stored library (or a stored version of a library). Matching patterns can enable the meta-information parser 134 to access the library and versions of dependencies declared in the meta-information file. This information can also be compared to the results of the method transformer 128 and library transformer 131 to estimate which libraries are included in the application.

The voting system 136 can aggregate the predictions from each tool (the method transformer, the library transformer, and the meta information parser). Each system can identify one or more third-party libraries determined to be included within the application. The voting system can then use a majority voting process to predict which third-party libraries and versions are included. In some examples, different systems can have different voting weights. For example, the voting system 136 may have greater weight than the other two systems. The system can reconcile conflicting predictions and generate a list of predicted third-party libraries 138.

The list of predicted third-party libraries can be analyzed to determine, for each predicted library, whether the third-party library has any associated vulnerabilities, errors, or malicious code. The voting system 136 can generate a report that lists all potential issues, which can be provided to the user as requested or provided to the application developer.

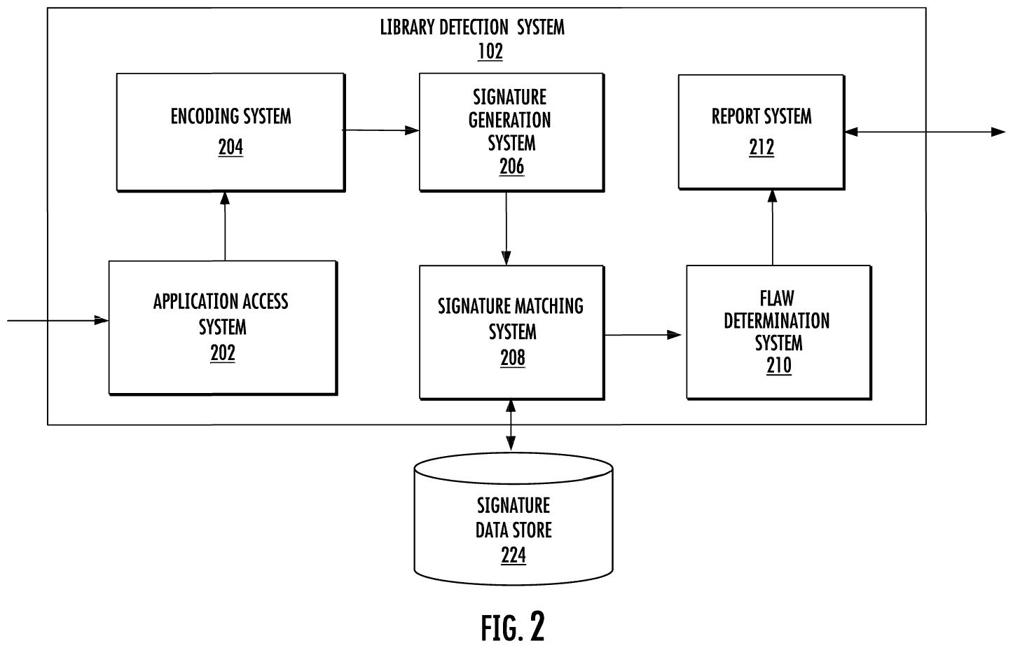

FIG. 2 depicts an example library detection system 102 associated with a computing system according to example embodiments of the present disclosure. In this example, the library detection system 102 can be implemented by a computing system that can communicate with other computing systems. The computing system can include one or more processors, memory for storing instructions, one or more input devices, and one or more devices capable of communicating with other computing systems.

The library detection system 102 can include an application access system 202, an encoding system 204, a signature generation system 206, a matching system 208, a flaw determination system 210, a report system 212, and a signature data store 224.

The application access system 202 can access an application. Depending on the specific operating system, the application access system 102 can access a particular file or group of files for a specific application. For example, if the operating system is Android, the application can access the APK (Android package kit), which contains all the data the application needs to execute, including all the software associated with the program's code (e.g., byte code), all the assets used by the program, and any resources used by the program.

Once the application access system 202 has accessed the APK or other application program, it can parse the application to identify one or more subgroups of instructions with the application that are associated grouped together to perform particular functionality. In some examples, the application access system 202 can determine that instructions (or groups of instructions) are part of the application's core code and are thus not part of a third-party library. The application access system 202 can determine that other instructions (or groups of instructions) are candidates for potential third-party libraries that are included in the application. The application access system 202 can generate a list of the methods or classes potentially associated with third-party libraries. The application access system 202 can transmit that list of methods and/or classes (or any instruction subgroup) to the encoding system 204.

The encoding system 204 can generate an encoded representation of the instructions included in each code module. In some examples, the encoding process is a fuzzy process in which groups of instructions can all be given the same symbol when encoded. For example, the encoding system 204 can group instructions that can be easily substituted for one another (e.g., as part of an obfuscation scheme) so that they all receive the same symbol when encoded. In this way, the encoded representation of the application's instructions represents a broad representation of the operations performed by the method and not the specific instructions used to perform that method. Generalizing in this way allows the library detection system 102 to identify third-party libraries even if those libraries have been modified or obfuscated in some way.

The signature generation system 206 can access the encoded representation of instructions for each code module. In addition, the signature generation system 206 can generate a signature header that represents the title of the library as well as the input variables (including both the number of variables and the type of each variable) and the output of each method (including the data type). The signature generation system 206 can generate a signature header that represents these values in a generalized way. The signature generation system 206 can generate the signature body by generating a hash based on the encoded instruction sequence.

Once one or more candidate software signatures are generated by the signature generation system 206, the matching system 208 can determine whether any stored signatures in the signature data store 224 matches one or more candidate software signatures from the target application. In some examples, the system can decide whether or not they match using a harmonic comparison process. In other examples, a Levenshtein distance can be calculated to determine the number of changes needed to move from one software signature to the other. The matching system 208 can determine whether the comparison between each candidate software signature and stored software signature satisfies a threshold value. If so, the two software signatures are determined to match. In some examples, the threshold value is determined based on ranking all candidate stored library signatures.

In other examples, a fixed similarity score can determine the threshold value. Thus, any pair of a generated candidate software signature and a stored software signature with a similarity above the threshold score can be determined to be matched. Once the matching system 208 determines one or more third-party libraries is determined to be in the target application, the flaw determination system 210 can determine whether those libraries contain any flaws, errors, vulnerabilities, or malicious code that would be important when evaluating an application. In some examples, the matching system 208 determines not only the specific library but also a particular version of the software third-party library included in the application. The flaw determination system 210 can determine whether that specific version has flaws or vulnerabilities that the user who requested the review should know.

The report system 212 can generate a report for the user that includes a list of all potential vulnerabilities and other issues with the code. This report can be transmitted to a user for review or display on the user's computer.

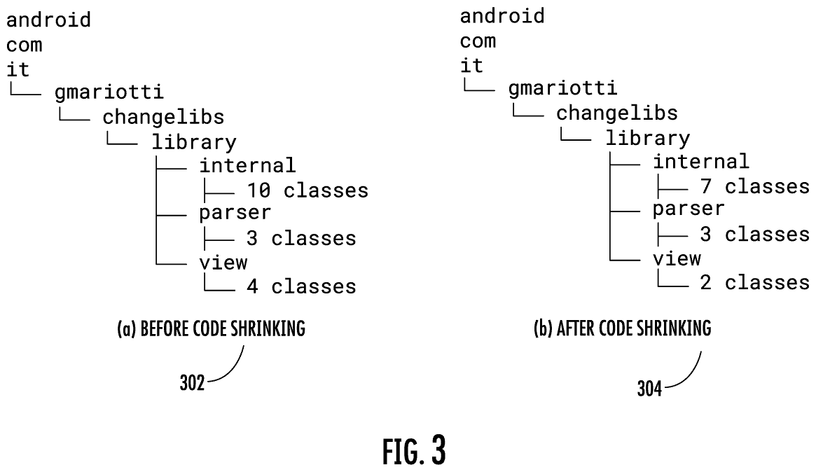

FIG. 3 represents an example of the result of code shrinking in accordance with example embodiments of the present disclosure. This example shows a library package structure before code shrinking 302 and after code shrinking 304. The application includes three code modules in this example: the internal model, the parser module, and the view module. Before shrinking, the internal module has ten classes, the parser module has three classes, and the view module has four classes. However, when compiled or put into executable form, a compiler can eliminate redundant code or code not used by the program. Because most libraries include various classes and methods to provide different functionalities, most applications only use a part of the functionality provided by a third-party library.

The three code modules will have fewer classes after shrinking 304. The internal module now has seven classes, the parser module now has three classes, and the view now has two classes. As a result, any library detection system that does not use fuzzy matching or other types of generalization will fail to determine that the shrunk code includes an internal module, a parser module, or view module because they have an incorrect number of classes when directly compared to the pre code shrinking 302 version of those modules.

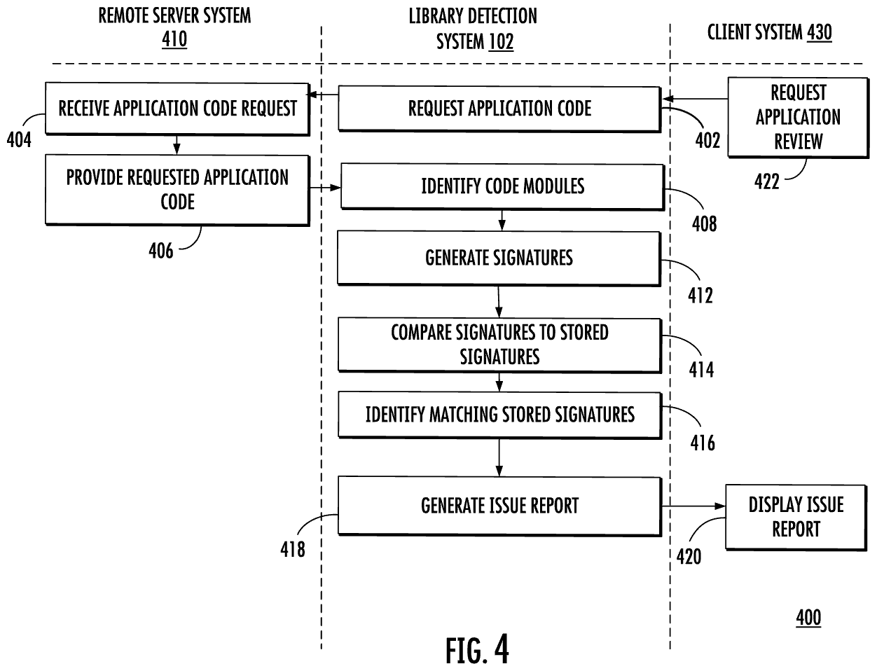

FIG. 4 is an example of a process for determining whether an application includes third-party libraries that include flaws, vulnerabilities, and/or malicious code in accordance with the example embodiments of the present disclosure. In some examples, the library detection system 102 can determine that an application is to be evaluated (e.g., based on a user request). The library detection system 102 can request, at 402, the requested application. For example, the application can be a group of files that enable a computer to perform the functionality of the application when executing the instructions in the files.

The request for the application can be transmitted to a remote server system 410. The remote server system 410 can receive, at 404, the application request. In this example, the remote server system 410 can store the application (e.g., an APK for the application) for one or more operating system environments and different versions of those operating system environments. In response to the request for the application, the remote server system 410 can provide the requested application, at 406, to the library detection system 102. In some examples, the application can be in the form of an executable file or set of files. In some examples, this can be an APK. The APK (Android package kit) can be a group of one or more files containing all the data the application needs to execute properly, including all the software associated with the program's code, all the assets needed by the program, and any resources needed by the program.

The library detection system 102 can identify, at 408, one or more code modules within the application data. In some examples, the code modules can be one or more classes and methods that are distinct from each other. For example, if a particular class is included in another class, those two classes can be grouped into the same code module. If two classes within the application are distinct such that neither includes the other, the library detection system 102 can determine that they are different code modules. The library detection system 102 can generate a list of the code modules in the application data. In some examples, one or more of the code modules can be determined to be core code modules. Core code modules can be distinguished from code modules that are third-party library code modules. If so, the system may only access the third-party library code modules in the list of code modules.

In some examples, the library detection system 102 can generate signatures for 112 for each code module and a signature for the entire library itself. As noted above, the library detection system 102 can generate an encoded version of the instructions for the methods in each code module. The library detection system 102 can generate a signature header based on the method inputs and outputs of the methods included in the code module. The signature body can be generated using a hash function on the encoded string representing the contents of the methods.

The library detection system 102 can compare, at 414, the generated signatures to stored library signatures in the library database. In some examples, the library detection system 102 can make this comparison by determining, for each generated signature, a similarity to each stored library signature. As discussed above, the similarity between two software signatures can be determined based on Levenshtein distance or another measurement of similarity between two hashes. In some examples, the library identification system can determine, at 416, which libraries are present in the application based on which stored library signatures match the generated signatures. For example, any stored library signature that matches at least one generated signature with a similarity score above a threshold, is determined to be present in the application.

Once the library verification system for 100 has determined which third-party libraries are likely included in the current application, it can generate, at 418, an issue report 418 identifies any issues with the third-party libraries included. As discussed, issues can consist of flaws, errors, vulnerabilities, and potentially malicious code. The library detection system 102 can transmit the report to the client system 430. The client system for 30 can display, at 420, the issue report to the user.

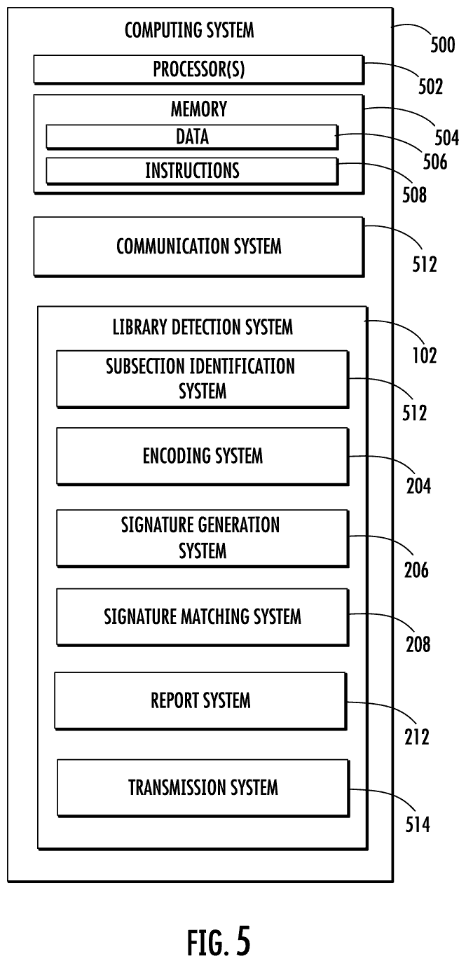

FIG. 5 depicts an example computing system 500 in accordance with example embodiments of the present disclosure. In some example embodiments, the computing system 500 can be any suitable device, including, but not limited to, a personal computer, a laptop computer, a workstation computer, or any other computing system that is configured such that it can receive communications via a computer network and transmit communications to the other computing systems via the network. The computing system 500 can include one or more processor(s) 502, memory 504, a communication system 512, and a library detection system 102.

The one or more processor(s) 502 can be any suitable processing device, such as a microprocessor, microcontroller, integrated circuit, or another suitable processing device. The memory 504 can include any suitable computing system or media, including, but not limited to, non-transitory computer-readable media, RAM, ROM, hard drives, flash drives, or other memory devices. The memory 504 can store information accessible by the one or more processor(s) 502, including instructions 508 that can be executed by the one or more processor(s) 502. The instructions can be any set of instructions that, when executed by the one or more processor(s) 502, cause the one or more processor(s) 502 to provide the desired functionality.

In particular, in some devices, memory 504 can store instructions for implementing the communication system 512 and the library detection system 102. The computing system 500 can implement the communication system 512 and the library detection system 102 to execute aspects of the present disclosure, including determining whether a particular application includes one or more third-party libraries.

It will be appreciated that the terms “system” or “engine” can refer to specialized hardware, computer logic that executes on a more general processor, or some combination thereof. Thus, a system or engine can be implemented in hardware, application-specific circuits, firmware, and/or software controlling a general-purpose processor. In one embodiment, the systems can be implemented as program code files stored on a storage device, loaded into memory, and executed by a processor or can be provided from computer program products, for example, computer-executable instructions, that are stored in a tangible computer-readable storage medium such as RAM, hard disk, or optical or magnetic media.

Memory 504 can also include instructions 508 and data 506, such as applications and software signatures available to the library detection system 102, that can be retrieved, manipulated, created, or stored by the one or more processor(s) 502. As noted above, the computing system 500 includes a communication system 512, the library detection system 102, and other system components not pictured in FIG. 5.

The communication system 512 can receive communications from remote computing systems over a communication network. The communications can include, for example, a request from a user computing device (e.g., the client system 430 in FIG. 4) to evaluate a particular application. For example, a user can be in the process of assessing an application for installation on their computing device. One of the steps the user may take to evaluate the application is to submit it to the library detection system 102 for analysis with respect to security vulnerabilities resulting from any included third-party libraries. The request could, therefore, include an identifier for the target application to be evaluated and any other relevant information about the application.

The library detection system 102 can include a subsection identification system 512, an encoding system 204, a signature generation system 206, a signature matching system 208, a report system 212, and a transmission system 514.

In some examples, the communication system 512 can transmit requests or receive responses from a remote server system providing access to the application (or application data). In this example, the library detection system 102 may have previously requested an application from the remote server system. The communication can be a response to that request, including the requested information.

If the library detection system 102 receives a request to evaluate a particular application, the library detection system 102 can access an application (e.g., a file or files that enable execution of the application). For example, an application can be configured to run in an Android™ or iPhone™ operating system environment. The library detection system 102 can determine which specific operating system and version the application is associated with and access the application executable files associated with that operating system and version.

Once the library detection system 102 has received the application data, the subsection identification system 402 can determine, based on the application data, one or more set code modules or subsections that represent individual groupings of classes and methods within the portion of the application data representing libraries. For example, if a particular group of classes and methods interact with each other they can be grouped together in the same code module. However, if a specific class and or method is distinct from the others and does not interact with them (e.g., does not call other classes or methods), that class and our method can be designated as its own code module. In some examples, the subsection identification system 402 can determine a list of potential library candidates to be compared against stored library signature data.

The list of library candidates (e.g., distinct code modules within the application data) can be provided to the encoding system 204. The encoding system 204 can encode the instructions included in each class and method into an encode string that represents the contents of a particular code module. For example, each computer instruction can be associated with a particular symbol. As noted above, similar or interchangeable instructions can be associated with the same symbol. In this way, obfuscation attempts that swap out similar instructions for each other can be mapped to the same symbol. The encoding system 204 can generate an embedded representation of a particular code module's contents by replacing each instruction with the symbol with which it is associated. As a result, the output of the encoding system 204 can include one or more encoded strings representing the contents of one or more methods and/or classes.

The signature generation system 206 can generate signatures for each library and code module. The signature heading can be generated based on the title of the module, class, or method as well as the input variables and their types and the output variables and their types. The body of the signature can be generated by using a rolling hash on the encoded representation of the contents of the methods and their classes. The header and the body can be combined into a single software signature for each candidate code module and each library.

The signature matching system 208 can, for each candidate generated signature, determine a match score with each stored library signature. The signature matching system 208 can determine the degree to which each generated signature matches one or more stored software signatures. The signature matching system 208 can select one or more libraries meeting particular criteria. For example, the signature matching system 208 can select the third-party library whose stored software signature best matches the generated software signatures. This selection method may result in only a single third-party library being identified. In other examples, the signature matching system 208 can select the third-party libraries with stored library signatures with a match score (e.g., a match percentage or other score) that exceeds a particular threshold. A list of selected third-party libraries can be passed to the report system 212.

The report system 212 can determine one or more vulnerabilities, flaws, or malicious code segments included in the libraries determined to be in the application. The report system 212 can generate a report that includes this information. The transmission system 514 can transmit the report to the user who requested the application analysis in the first place.

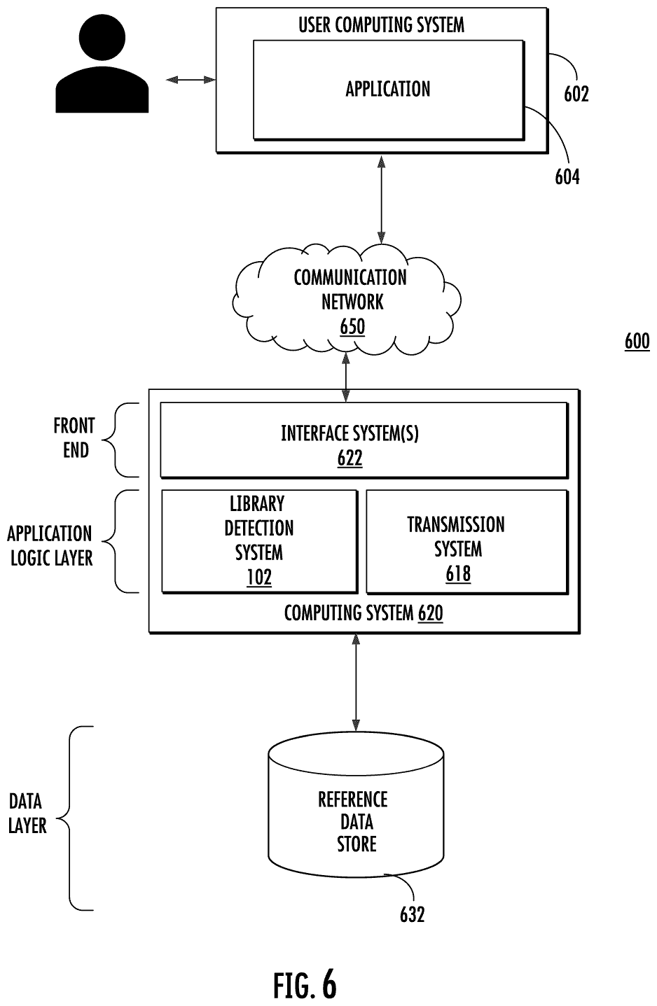

FIG. 6 depicts an example client-server environment 600 according to example embodiments of the present disclosure. The client-server system environment 600 includes one or more user computing systems 602 and a computing system 620. One or more communication networks 650 can interconnect these components. The one or more communication networks 650 may be any of a variety of network types, including local area networks (LANs), wide area networks (WANs), wireless networks, wired networks, the Internet, personal area networks (PANs), or a combination of such networks.

A user computing system 602 can be one of, but is not limited to, a personal computing system, a smartphone, a smartwatch, a laptop computing device, and a tablet computing system. In some examples, the user computing system 602 can include one or more application(s) 604, such as search applications, communication applications, navigation applications, productivity applications, game applications, word processing applications, or any other applications. The application(s) can include a web browser. The user computing system 602 can use a web browser (or other application) to send and receive requests to and from the computing system 620. The user computing system 602 can request that the computing system 620 evaluate a particular application to determine if it includes any third-party libraries with flaws or security issues. The computing system 620 can assess the application and transmit a library report to the user computing system 602.

As shown in FIG. 6, the computing system 620 can generally be based on a three-tiered architecture, consisting of a front-end layer, application logic layer, and data layer. As is understood by skilled artisans in the relevant computer and Internet-related arts, each component shown in FIG. 6 can represent a set of executable software instructions and the corresponding hardware (e.g., memory and processor) for executing the instructions. To avoid unnecessary detail, various components and engines that are not germane to conveying an understanding of the various examples have been omitted from FIG. 6. However, a skilled artisan will readily recognize that various additional components, systems, and applications may be used with a computing system 620, such as that illustrated in FIG. 6, to facilitate additional functionality that is not specifically described herein. Furthermore, the various components depicted in FIG. 6 may reside on a single server computer or may be distributed across several server computers in various arrangements. Moreover, although computing system 620 is depicted in FIG. 6 as having a three-tiered architecture, the various examples of embodiments are not limited to this architecture.

As shown in FIG. 6, the front end can consist of an interface system(s) 622, which receives communications from one or more user computing system 602 and communicates appropriate responses to the user computing system 602. For example, the interface system(s) 622 may receive requests in the form of Hypertext Transfer Protocol (HTTP) requests, or other web-based application programming interface (API) requests. The user computing system 602 may be executing conventional web browser applications or applications developed for a specific platform to include any of a wide variety of computing devices and operating systems.

As shown in FIG. 6, the data layer can include a signature data store 632. The signature data store 632 can store a plurality of software signatures for a plurality of third-party libraries (or portions of the third-party libraries). The signature data store 632 can store, for each library, a list of any potential flaws, issues, vulnerabilities, or malicious code. In some examples, the library can include signatures for a plurality of versions of each application. For example, an updated version of an application can include revisions that result in different third-party libraries being included.

As a result, the signature data can also be updated to represent the new revisions of the application. The signature data for each application (and each version of the application) can be stored in the signature reference data store 632. The computing system 620 can compare the software signatures that it generates with the stored software signatures. Once the system determines third-party libraries are included the target application, the system can access data describing the particular attributes of the third-party library (e.g., any flaws or malicious code) based on data stored in the signature reference data store 632.

The application logic layer can include application data that can provide a broad range of other applications and services that allow users to request an analysis of the third-party libraries included in a particular application. The application logic layer can include a library detection system 102 and a transmission system 618.

When a user computing system 602 transmits a request to the computing system 620 to evaluate a target application, interface system 622 can extract the relevant information about the request (e.g., an identifier of the application, the intended operating system and version, and so on). In some examples, the request itself could include the target application.

The library detection system 102 can access third-party libraries and generate software signatures for those libraries. In this way, the computing system 620 can, for all known third-party libraries, store software signatures for those third-party libraries. The computing system 620 can store these software signatures as a reference for the library detection system 102 when determining whether a particular target application includes the third-party libraries. The library detection system 102 can access third-party libraries for different operating systems, different programming languages, and different versions of the third-party libraries.

For example, if a particular third-party library has a flaw in its first version, the developers may release a second version that corrects the flaw. The library detection system 102 can generate different software signatures for each version of the third-party library. In this way, the library detection system 102 can determine which version of a third-party library is included in a target application.

The library detection system 102 can receive a request to analyze a target application. To do so, the library detection system 102 can access the byte code of the application. Using that data, the library detection system 102 can generate one or more software signatures for candidate libraries within the target application.

Once the one or more software signatures have been generated, the library detection system 102 can compare the generated software signatures from the target application against the stored software signatures from the third-party libraries. The library detection system 102 can generate a similarity score for all pairs of generated software signatures (from the target application) and stored software signatures (from third-party libraries).

The library detection system 102 can use the resulting similarity scores to determine which third-party libraries are included in the target application. In some examples, the target application can include one third-party library and the library detection system 102 determines the third-party library associated with the stored software signature with the highest similarity score to one of the generated software signatures. In other examples, the target application can include more than one third-party library and the library detection system 102 identifies any third-party library with a similarity score above a threshold value.

Once the library detection system 102 determines one or more third-party libraries included in the target application, the library detection system 102 can generate a report for the target application indicating which libraries are included and what potential problems exist for those third-party libraries. The report can be transmitted to and displayed on the user computing system 602 that transmitted the request.

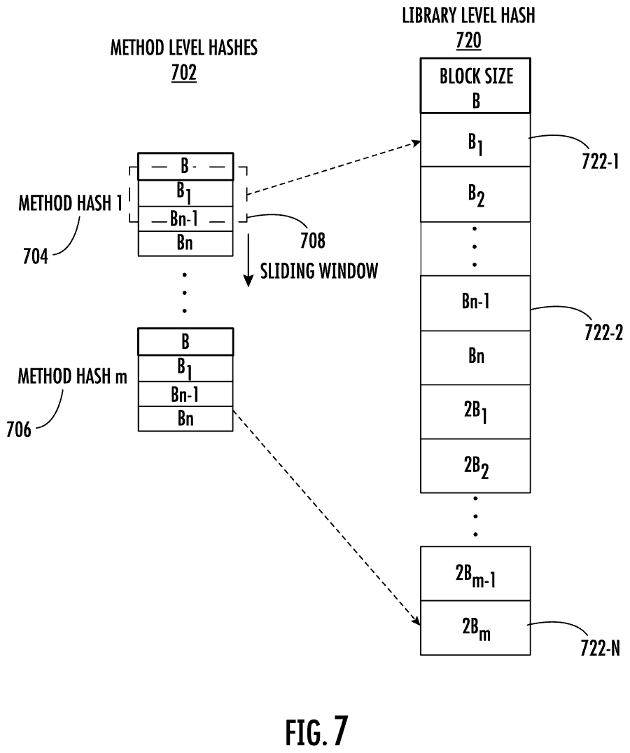

FIG. 7 depicts a method level hash and a library level hash according to example embodiments of the present disclosure. In this example, a library detection system can dissemble the code associated with a target application (or third-party library). The disassembled byte code can be encoded into a compact representation encoding instruction mnemonics.

The compact representation can be hashed to generate a series of method level hashes 702. The signature header can be constructed by mapping non primitive parameter or return types to a fuzzy type and preserving primitive types. The signature body is a fuzzy rolling context-triggered piecewise hash of the encoded instruction mnemonics. The fuzzy hash has two parts: one of block size B and another of block size 2B. The hashes generated from methods included in a particular third-party library or code module in a target application can be listed from method hash 1 704 to method hash m 706.

The library detection system can use the method hashes to generate the library level hash 720. Specifically, the library detection system can use a sliding window 708 that generates a block of block size B from a group of method level hashes. In this example, method hashes B₁ and Bₙ₋₁ can be used to generate block B₁ in the library level hash 722-1.

In some examples, some blocks in the library level hash 720 have size 2B. For example, block 2B₁ 722-2 has a hash size that is 2B.

Doubling the block size helps maintain the similarity in the presence of larger structural changes than would span more than one block of data but do not necessarily impact the overall contextual information in the blocks. This improves the precision and accuracy of the technique. To illustrate, it is similar to using two different lenses when determining when two objects are the same. A measurement can be taken using a first lens (with a magnification of 1). The user can then take another measurement with a second lens (with a magnification of 0.5). The second lens may allow less detail (e.g., be blurrier). The final similarity assessment can be based on the two different views.

The library level hash 720 can be a rolling fuzzy hash of all the method level fuzzy hashes in the library. The method level hash 702 can be deconstructed where only the block size B component is kept. All of the hashes block size B components are concatenated together and then hashed in the same manner as the method level hash.

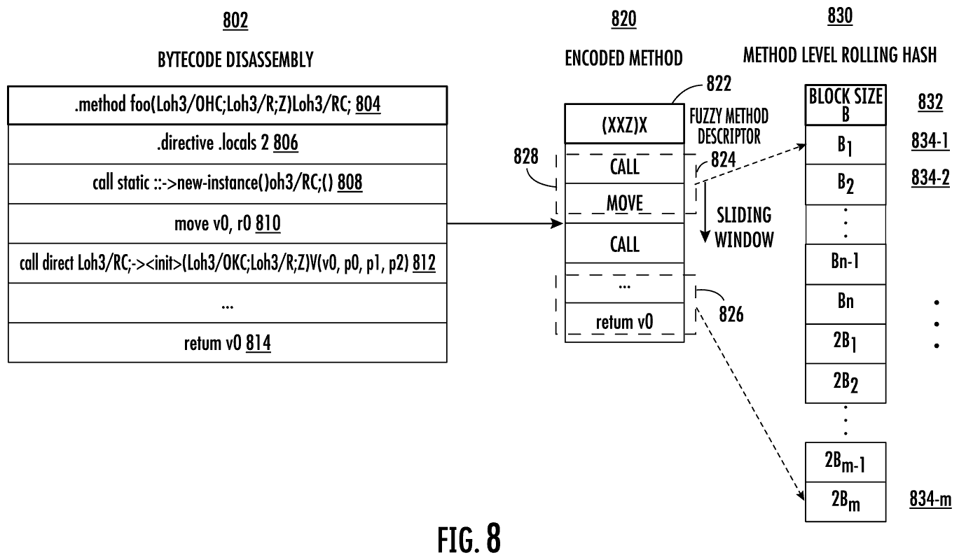

FIG. 8 depicts a process for encoding computing instructions according to example embodiments of the present disclosure. In this process the library detection system can disassemble the executable files to produce the disassembled bytecode 802. The library detection system can generate an encoded representation of the disassembled bytecode. To do so, each instruction in the bytecode can be used to generate a symbol in a series of symbols.

Once the content of one or more methods has been encoded, the encoded method 820 can be used to generate a software signature for the library. The header 822 can be a fuzzy method descriptor. The body of the encode method can include a series of generalized representations of specific instructions 828. The encode method can be hashed using a sliding window (e.g., sliding from 824 to 826). This process produced the method level rolling hash 830. The method level rolling has can include a series of blocks of block size B (e.g., 834-1, 834-2, . . . 834-m).

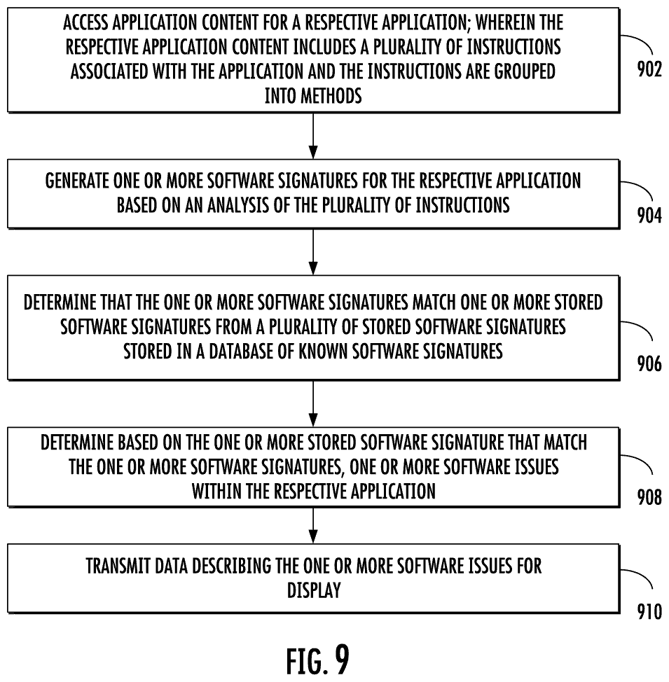

FIG. 9 depicts an example flow diagram for a method of identifying third-party libraries within applications according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 2, 5, and 6.

A computing system (e.g., computing system 500 in FIG. 5) can include one or more processors, memory, and one or more input devices. The one or more input devices can include a keyboard, a mouse, a microphone, and so on. The computing system (e.g., computing system 500 in FIG. 5) can include other components that, together, enable the computing system (e.g., computing system 500 in FIG. 5) to evaluate the manifest files associated with a respective application upon request.

The computing system (e.g., computing system 500 in FIG. 5) can, at 902, access application content for a respective application; wherein the respective application content includes a plurality of instructions associated with the application and the instructions are grouped into methods. In some examples, the application content can be an executable file. In some examples, the computing system can disassemble the executable file to access the byte code of the application. In some examples, the instructions can be grouped into a hierarchical structure. For example, the instructions can include one or more code modules, each module including one or more classes and each class including one or more methods.

The computing system (e.g., computing system 500 in FIG. 5) can, at 904, generate one or more software signatures for the respective application based on an analysis of the plurality of instructions. In some examples, the computing system (e.g., computing system 500 in FIG. 5) can determine one or more software subsections within the plurality of instructions. The one or more software subsections can include methods within the plurality of instructions.

The computing system (e.g., computing system 500 in FIG. 5) can generate a distinct software signature for each software subsection. In some examples, the software signatures comprise a header section and a body section. The computing system (e.g., computing system 500 in FIG. 5) can identify, for a respective software subsection, one or more characteristics of the respective software subsection. In some examples, the one or more characteristics include one or more of: parameter types, return type, and method contents.

The computing system (e.g., computing system 500 in FIG. 5) can encode the parameter types and the return type using a fuzzy method descriptor to produce the header section of the software signature. The computing system (e.g., computing system 500 in FIG. 5) can generate an encoded representation of the method contents as the body section of the software signature. To do so, the computing system (e.g., computing system 500 in FIG. 5) can determine, for the respective software subsection, a plurality of instructions associated with the respective software subsection.

The computing system (e.g., computing system 500 in FIG. 5) can generate an encoded representation of the plurality of instructions associated with the respective software subsection by replacing each instruction with a symbol, wherein more than one instruction type is assigned to the same symbol. The computing system (e.g., computing system 500 in FIG. 5) can generate the body section of the software signature based on the encoded representation of the instructions associated with the respective software subsection. In some examples, the computing system (e.g., computing system 500 in FIG. 5) can hash the encoded representation of the plurality of the instructions associated with the respective software subsection using a context-triggered piecewise hashing process.

The computing system (e.g., computing system 500 in FIG. 5) can, at 906, determine that the one or more software signatures match one or more stored software signatures from a plurality of stored software signatures stored in a database of known software signatures. The computing system (e.g., computing system 500 in FIG. 5) can, for a respective stored signature in the plurality of stored software signatures, determine a similarity score between a respective software signature in the one or more software signatures and the respective stored software signature.

The computing system (e.g., computing system 500 in FIG. 5) can determine whether the similarity score satisfies a similarity threshold value. In accordance with a determination that the similarity score satisfies the similarity threshold, the computing system (e.g., computing system 500 in FIG. 5) can determine that the respective software signature matches the respective stored signature.

In some examples, the similarity threshold is predetermined. For example, if the similarity score is a value between 0 and 1, the similarity threshold can be 0.85. For example, the similarity score can be based on one or more of a Levenshtein distance and a Harmonic distance.

The computing system (e.g., computing system 500 in FIG. 5) can, at 908, determine, based on the one or more stored software signatures that match the one or more software signatures, one or more software issues within the respective application. In some examples, the software issues include a software vulnerability. In some examples, the software issues include malicious software. The computing system (e.g., computing system 500 in FIG. 5) can, at 910, transmit data describing the one or more software issues for display.

The technology discussed herein makes reference to sensors, servers, databases, software applications, and other computer-based systems, as well as actions taken, and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for identifying libraries used in applications, the method comprising:
accessing, by a computing system including one or more processors, application content for a respective application; wherein the application content includes a plurality of instructions associated with the application and the instructions are grouped into methods;
generating, by the computing system, one or more software signatures for the respective application based on an analysis of the plurality of instructions;
determining, by the computing system, that the one or more software signatures match one or more stored software signatures from a plurality of stored software signatures stored in a database of known software signatures;
determining, by the computing system, based on the one or more stored software signatures that match the one or more software signatures, one or more software issues within the respective application; and
transmitting, by the computing system, data describing the one or more software issues for display.

2. The computer-implemented method of claim 1, wherein generating, by the computing system, one or more software signatures for the respective application based on an analysis of the plurality of instructions further comprises
determining, by the computing system, one or more software subsections within the plurality of instructions.

3. The computer-implemented method of claim 2, wherein generating, by the computing system, one or more software signatures for the respective application based on an analysis of the plurality of instructions further comprises:
generating a distinct software signature for each software subsection.

4. The computer implemented method of claim 2, wherein the one or more software subsections include methods within the plurality of instructions.

5. The computer-implemented method of claim 1, wherein the software signature comprises a header section and a body section.

6. The computer-implemented method of claim 5, wherein generating, by the computing system, one or more software signatures for the respective application based on an analysis of the plurality of instructions further comprises:
identifying, by the computing system for a respective software subsection, one or more characteristics of the respective software subsection.

7. The computer-implemented method of claim 6, wherein the one or more characteristics include one or more of parameter types, return type, and method contents and the method further comprises:
encoding, by the computing system, the parameter types and the return type using a fuzzy method descriptor to produce the header section of the software signature.

8. The computer-implemented method of claim 7, generating, by the computing system, one or more software signatures for the respective application based on an analysis of the plurality of instructions further comprises:
generating, by the computing system, an encoded representation of the content of one or more methods as the body section of the software signature.

9. The computer-implemented method of claim 8, generating, by the computing system, an encoded representation of the method contents as the body section of the software signature further comprises:
determining, by the computing system, for the respective software subsection, a plurality of instructions associated with the respective software subsection; and
generating, by the computing system, an encoded representation of the plurality of instructions associated with the respective software subsection by replacing each instruction with a symbol, wherein more than one instruction type is assigned to the same symbol.

10. The computer-implemented method of claim 9, generating, by the computing system, an encoded representation of the method contents as the body section of the software signature further comprises:
generating, by the computing system, the body section of the software signature based on the encoded representation of the instructions associated with the respective software subsection.

11. The computer-implemented method of claim 9, wherein generating, by the computing system, the body section of the software signature based on the encoded representation of the instructions associated with the respective software subsection further comprises:
hashing, by the computing system, the encoded representation of the plurality of the instructions associated with the respective software subsection using a context-triggered piecewise hashing process.

12. The computer-implemented method of claim 1, wherein determining, by the computing system, that the one or more software signatures match one or more stored software signatures from a plurality of stored software signatures stored in a database of known software signatures further comprises:
for a respective stored signature in the plurality of stored software signatures:
determining, by the computing system, a similarity score between a respective software signature in the one or more software signatures and the respective stored software signature;
determining, by the computing system, whether the similarity score satisfies a similarity threshold value; and
in accordance that the similarity score satisfies the similarity threshold, determining that the respective software signature matches the respective stored signature.

13. The computer-implemented method of claim 12, wherein the similarity threshold is predetermined.

14. The computer-implemented method of claim 12, wherein the similarity score is based on one or more of a Levenshtein distance and a Harmonic distance.

15. The computer-implemented method of claim 1, wherein the software issues include a software vulnerability.

16. The computer-implemented method of claim 12, wherein the software issues include malicious software.

17. A computing system for evaluating applications automatically, the system comprising:
one or more processors and one or more non-transitory computer-readable memories;
wherein the one or more non-transitory computer-readable memories store instructions that, when executed by the processor, cause the computing system to perform operations, the operations comprising:
accessing application content for a respective application; wherein the application content includes a plurality of instructions associated with the application and the instructions are grouped into methods;
generating one or more software signatures for the respective application based on an analysis of the plurality of instructions;
determining that the one or more software signatures match one or more stored software signatures from a plurality of stored software signatures stored in a database of known software signatures;
determining based on the one or more stored software signature that match the one or more software signatures, one or more software issues within the respective application; and
transmitting data describing the one or more software issues for display.

18. The computer system of claim 17, wherein generating one or more software signatures for the respective application based on an analysis of the plurality of instructions further comprises
determining one or more software subsections within the plurality of instructions.

19. The computer system of claim 18, wherein generating one or more software signatures for the respective application based on an analysis of the plurality of instructions further comprises:
generating a distinct software signature for each software subsection.

20. A non-transitory computer-readable medium storing instruction that, when executed by one or more computing devices, cause the one or more computing devices to perform operations, the operations comprising:
accessing application content for a respective application; wherein the application content includes a plurality of instructions associated with the application and the instructions are grouped into methods;
generating one or more software signatures for the respective application based on an analysis of the plurality of instructions;
determining that the one or more software signatures match one or more stored software signatures from a plurality of stored software signatures stored in a database of known software signatures;
determining based on the one or more stored software signature that match the one or more software signatures, one or more software issues within the respective application; and
transmitting data describing the one or more software issues for display.
